(19) United States
(12) Patent Application Publication
(10) Pub. No.: US 2005/0106533 A1
(43) Pub. Date: May 19, 2005

(54) Cofferdam covering means and strip-shaped fastening means for the same

(76) Inventors: Werner Mannschedel, Langenau (DE); Barbara Muller, Langenau (DE)

Correspondence Address: Ronald R Santucci;Frommer Lawrence & Haug, 745 Fifth Avenue, New York, NY, 10151, US

(21) Appl. No.: 10/505,188

(22) PCT Filed: Feb. 25, 2003
(86) PCT No.: PCT/EP03/01924

(30) Foreign Application Priority Data
Feb. 28, 2002 (DE) 102 08 639.7

(51) Int. Cl. A61C 5/14

(52) U.S. Cl. 433/136

(57) ABSTRACT

A sheet-like rubber dam covering means (10) and/or a strip securing means of a rubber dam is produced from a flexible, elastic material. In order to provide a covering means and/or a securing means that has, especially, excellent properties in respect of tearing and stretching behaviour, the material chosen is an elastic thermo-plastic material.

The invention relates to a rubber dam covering means, and to a strip securing means therefor, of a flexible, elastic material. The invention relates also to a rubber dam having such a rubber dam covering means and/or strip securing means.

A rubber dam has long been known in dentistry as an aid in isolating and drying teeth being treated. There is used as the covering means a rubber (natural rubber) or latex sheet in which a hole is formed and which is so arranged in the oral cavity that it covers the oral mucosa while the upper portion of a tooth being treated is freely accessible. For securing the sheet in the oral cavity there is generally used a rubber dam clamp or a strip securing means which is clamped over the tooth being treated or in between two teeth.

The covering means and the securing means must meet narrowly defined standards in respect of their elasticity, their stretching ability and their resistance to tearing. At the same time the covering means must be sufficiently capable of being adapted to the contours of the oral cavity without the formation of troublesome bulges and folds.

The problem underlying the invention is to provide a rubber dam covering means and a strip securing means having the properties mentioned above. At the same time it is especially intended that advantageous interactions between those properties should be achieved.

That problem is solved according to the invention by a sheet-like rubber dam covering means mentioned at the beginning and by a strip securing means, in which the material is an elastic thermoplastic material. The problem is also solved by a rubber dam in which such a rubber dam covering means and/or a strip securing means is used.

The use of an elastic thermoplastic material as the material for a rubber dam contrasts with the customary use of rubber (natural rubber) or latex as the material. While latex is used for the production of elastomers, thermoplastic mouldings are produced by melting and subsequent solidification. In comparison with elastomers, thermoplastic materials basically have, in particular, a considerably lower degree of elasticity, that is to say they are not able to undergo substantial changes in shape and, after being relieved of load, immediately return to the starting state again. In the first instance, therefore, they do not appear to be a suitable material for a rubber dam covering means and/or a strip securing means.

According to the invention, there is used for the covering means and, at the same time or alternatively, for the securing means a thermoplastic material to which elastic properties have been imparted by suitable melting and solidification processes and optionally the addition of suitable fillers and/or plasticisers.

The use of an elastic thermoplastic material brings the surprising advantage that the covering means has a considerably lower tendency to tear at a “weak spot”. Such weak spots are, for example, holes, such as those formed in a rubber dam covering means for a tooth being treated. Since the covering means according to the invention and the securing means according to the invention almost never tear by themselves, the necessary holes can be formed more precisely and more durably and the strip securing means can be subjected to greater stretching for the purpose of application between two teeth than in the case of conventional securing means. On being stretched, the securing means according to the invention becomes smaller in cross-section, especially in the middle, it being particularly simple to introduce the securing means between two teeth on account of its substantially reduced cross-section.

The material according to the invention has at the same time very good stretching ability as well as a very high degree of elasticity and flexibility, that is to say it can be adapted very satisfactorily, without folds, to the contours of an oral cavity. When used in the form of a strip securing means, the material returns especially advantageously to its starting position, thus creating a strong hold between two teeth.

In an advantageous development of the invention, an elastic thermoplastic material is used which, when stretched in the longitudinal direction, exhibits an almost linear force-displacement characteristic curve. A material having such behaviour allows especially user-friendly handling. When used as a strip securing means it can be cut to length as required by the treating physician or user and thus the risk of improper handling and tearing can be kept very low. When adapting holes in a rubber dam covering means to the teeth being treated, the treating physician or user can utilise the size of a hole to determine the contact pressure of a covering means on the edges of the tooth. By virtue of the linear force-displacement curve when the material developed according to the invention is being stretched, the correlation between the size of the hole and the contact pressure achieved is linear. For a user, that linear behaviour can readily be understood. If he enlarges the hole, the contact pressure is reduced accordingly. Such behaviour is almost independent of the absolute size of the hole.

A rubber dam covering means has an underside that is to be arranged facing the oral mucosa and an upper side remote therefrom. Elastic plastomers used according to the invention are by their nature tacky on the surface. This is initially an advantage because the tackiness improves the adhesion of the covering means or securing means to a tooth. When the covering means or securing means is being put in place, however, the surfaces may come into contact with one another and stick together, or it may be that a covering means cannot be pulled over a tooth or a securing means cannot be inserted between two teeth. The handling ability of the covering means or securing means according to the invention might thus be impaired. In a development according to the invention, however, a side, the underside and/or the upper side, is provided with an absorbent surface, which is especially in the form of a flock coating of absorbent fibres or in the form of an applied non-woven material.

In an additional or alternative development according to the invention, a side, the underside and/or the upper side, is provided with a structured surface. The terms “structured surface” and “surface structure” are intended to be understood in this context as being a surface which is not smooth but has been specifically provided with raised areas and/or depressions. The structured surface provided according to the invention has the effect of reducing the contact surface area as a whole. The surface area of the covering means or securing means having an adhesive action is thus also reduced. At the same time, the use of a lubricant is unnecessary.

The surface structure advantageously has a large number of depressions which, starting from the surface plane of the side in question, extend in the direction of the remote side. With this kind of surface, the surface plane is substantially retained as contact surface, so that a relatively high adhesive action is obtained on the side in question.

Advantageous dimensions for the depressions in the covering means or securing means developed according to the invention are an extent of from 0.10 mm to 0.50 mm, especially from 0.20 to 0.40 mm, in the surface plane and a spacing of from 0.05 mm to 0.30 mm, especially from 0.10 mm to 0.25 mm. In order to provide sufficient spacing from the contact surface and at the same time in order not to reduce the tear resistance of the covering means or securing means, the depressions each have, starting from the surface plane, a depth of from 0.05 mm to 0.30 mm, especially from 0.10 to 0.20 mm.

The depressions are especially advantageously of point-form or honeycomb configuration. A covering means or securing means so structured has similar properties to a woven fabric, that is to say while having a high degree of flexibility and a low tendency towards bulging and fold formation, it has a high resistance to tearing. This is achieved by the “webs” that remain between the honeycomb cells of a covering means so structured. The said webs advantageously extend at right angles to one another, the depressions each having a rectangular, especially square, cross-section in the surface plane. A covering means so structured has a relatively uniformly characteristic stretching behaviour in all directions of the surface plane.

Alternatively, the depressions can each have a hexagonal, especially an equilaterally hexagonal, cross-section in the surface plane. Furthermore, the depressions can be of groove-like structure. With the aid of such grooves, it is possible especially for bulging or folding of the covering means or securing means in certain regions and/or in certain directions to be selectively facilitated.

Such a selective “weakening” of the covering means or securing means at certain places or in certain regions can also be used independently of the thermoplastic material mentioned in the characterising clause of claim 1 as a material for the rubber dam covering means, for example in order to create a covering means which can be adapted especially easily and durably to the contours of the oral cavity. In order to be able to provide places or regions in the covering means that are especially readily capable of stretching, bulging or folding it is possible for both point-form and linear depressions to be provided singly or in greater numbers immediately one next to the other or spaced further apart from one another.

The depressions developed according to the invention can be formed especially economically by providing them with a dish-shaped structure, especially having rounded corners. Such a shape is also particularly advisable in respect of hygiene requirements.

In the covering means developed according to the invention it is also possible for the surface structures on the underside and the upper side to be different, so that two surfaces having different adhesive actions are available on a single covering means. In addition to the advantages already mentioned above, the adhesive or tacky surface also holds back drilling debris produced from the tooth being treated during a dental treatment procedure.

The above-mentioned fabric-like structure of the sheet-like covering means or strip-form securing means according to the invention is especially marked when the depressions on the underside are each arranged in the surface plane opposite the depressions on the upper side. Alternatively, the depressions on the underside can each be arranged in the surface plane offset relative to the depressions on the upper side. It is thus possible to produce a covering means or securing means which has the said advantages of a reduced contact surface area but at the same time, in terms of stretching behaviour and resistance to tearing, exhibits substantially the same behaviour as a conventional sheet of elastic plastomer that is smooth on both sides.

In addition to, or as an alternative to, the surfaces described above, the rubber dam covering means and/or strip securing means according to the invention can be produced from a coated material having layers consisting of different materials. Especially advantageous is a layer of elastic thermoplastic material combined with a layer of silicone/SEBS/Teflon. Such a covering means and/or securing means material has an especially high stretching ability with no risk of tearing. Furthermore, it is chemically resistant, can be easily disinfected and has no unpleasant taste.

### BRIEF DESCRIPTION OF THE DRAWINGS

An embodiment of a rubber dam covering means according to the invention will be described in greater detail below with reference to the accompanying diagrammatic drawings.

FIG. 1 is a perspective view of a rubber dam covering means according to the invention, and

FIG. 2 shows the detail 1 of FIG. 1.

### DETAILED DESCRIPTION OF THE EMBODIMENT

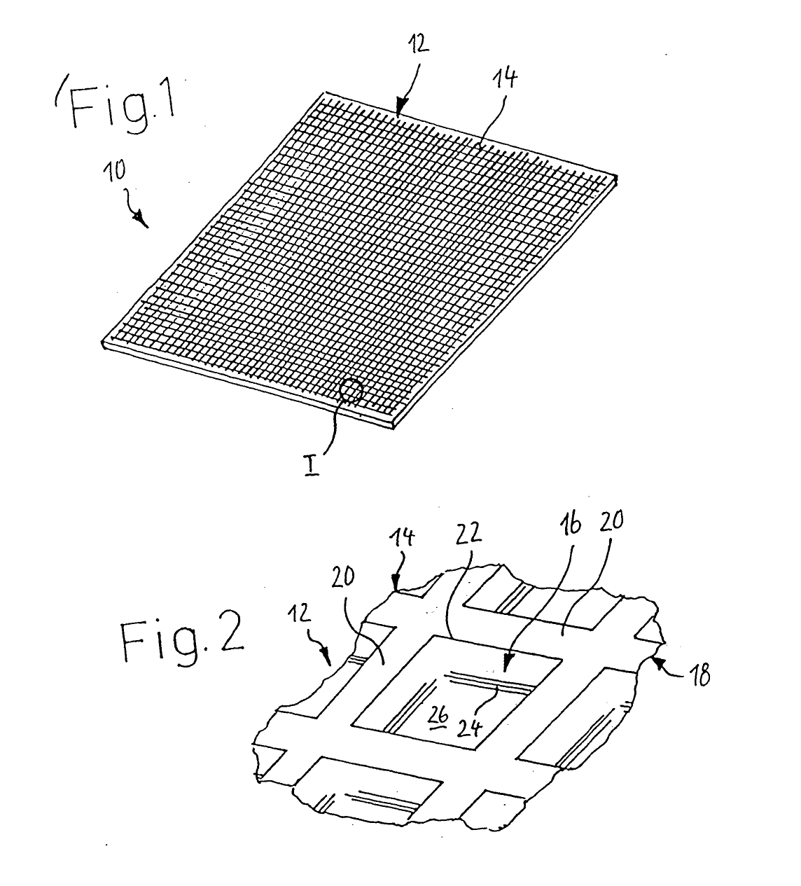

FIG. 1 shows a covering means 10 of a rubber dam (not shown) for dental surgical interventions. The covering means 10 essentially comprises an approximately 0.3 mm thick sheet, which is approximately square in shape with a side length of from 140 to about 150 mm.

A hole can be cut in the covering means 10, and during the intervention the covering means 10 can be pushed over a tooth being treated.

The covering means 10 is made from an elastic thermoplastic material, so that it has excellent properties in respect of resistance to tearing and stretching behaviour. The covering means 10 has an underside 12 which during an intervention is placed over the oral mucosa surrounding the tooth being treated and the adjacent teeth.

FIG. 2 shows that the covering means 10 has on the underside 12 not a smooth surface but a structured surface 14. This surface is formed by a plurality of dish-shaped depressions 16 which extend from a surface plane 18 on the underside in the direction of an upper side of the covering means 10 (not shown) remote from the underside 12. In this way the essentially tacky surfaces of the sheet of elastic thermoplastic material are prevented from adhering to one another too strongly.

The dish-shaped depressions 16 have, in the surface plane, square shapes having an extent of about 0.3 mm×0.3 mm. Such squares are arranged one next to the other in a grid having a spacing of about 0.1 mm, the upper edges 22 of the squares or depressions 16 being so arranged one next to the other that continuous webs 20 that intersect at right-angles are formed in the grid.

The depressions 16 have a depth of about 0.1 mm between the webs 20. Lower corners 24 of the depressions 16 are rounded. In between there are located base surfaces 26 of the depressions 16 which, on insertion of the covering means into the oral cavity, remain spaced apart from a further surface of the covering means, but rest against a tooth when pressed against it.

In a covering means of a rubber dam according to the invention that is not shown, the thermoplastic material is provided with a flock coating of absorbent fibres or an applied non-woven material, so that the material feels pleasant to a patient when inserted into an oral cavity and at the same time it can be easily handled.

The described materials and surfaces are especially advantageous also for the production of a strip securing means which is also known as “flexi-strip” and is used for insertion between two teeth, so that a rubber dam covering means located underneath cannot become displaced in the oral cavity.

The securing means is advantageously especially wedge-shaped, truncated-cone-shaped, elliptical, circular, square, rectangular or almost square or rectangular in cross-section with at least one inwardly or outwardly curved side.

### List of Reference Numerals

10 rubber dam covering means
12 underside
14 structured surface
16 depression
18 surface plane
20 web
22 upper edge
24 lower corner
26 base surface

1. Rubber dam covering means (10) or strip securing means of a flexible, elastic material,
wherein the material is a thermoplastic material that is elastic at room temperature,
the rubber dam covering means or strip securing means has an underside (12) that is to be arranged facing the oral mucosa and an upper side remote therefrom, and at least one side (12) is provided with a structured surface (14),
the surface structure (14) having a plurality of depressions (16) which, starting from a surface plane (18) of one side (12), extend in the direction of the remote side, and
the depressions (16) each have an extent of from 0.10 mm to 0.50 mm, especially from 0.20 mm to 0.40 mm, in the surface plane (18) and a spacing of from 0.05 mm to 0.30 mm, especially from 0.10 mm to 0.25 mm.

2. Rubber dam covering means or strip securing means according to claim 1,
wherein the elastic thermoplastic material has an almost linear force-displacement characteristic curve on being stretched in a plane of a sheet.

3. Rubber dam covering means or strip securing means according to claim 1,
wherein it is provided with an absorbent surface, especially in the form of a flock coating of fibres or an applied non-woven material.

4. Rubber dam covering means or strip securing means according to claim 1,
wherein the depressions (16) each have, starting from the surface plane (18), a depth of from 0.05 mm to 0.30 mm, especially from 0.10 mm to 0.20 mm.

5. Rubber dam covering means or strip securing means according to claim 1,
wherein the depressions (16) are of point-form configuration.

6. Rubber dam covering means or strip securing means according to claim 5,
wherein the depressions (16) each have a rectangular, especially square, cross-section in the surface plane (18).

7. Rubber dam covering means or strip securing means according to claim 1,
wherein the depressions (16) are of dish-shaped structure, especially having rounded corners (24).

8. Rubber dam covering means or strip securing means according to claim 1,
wherein it is composed of at least two layers of different materials and especially has a layer of silicone/SEBS/Teflon.

9. Rubber dam having a rubber dam covering means according to claim 1.
